(19) United States
(12) Patent Application Publication
(10) Pub. No.: US 2025/0074245 A1
(43) Pub. Date: Mar. 6, 2025

(54) Logistics Management System for EV Charging Station Use

(71) Applicants: Benjamin J. Kwitek, Colorado Springs, CO (US); Scott C. Harris, San Diego, CA (US)

(72) Inventors: Benjamin J. Kwitek, Colorado Springs, CO (US); Scott C. Harris, San Diego, CA (US)

(21) Appl. No.: 18/330,060

(22) Filed: Aug. 28, 2023

(51) Int. Cl. B60L 53/63; B60L 53/65; B60L 53/67; B60L 53/68; G06Q 10/0631

(52) U.S. Cl. CPC B60L 53/63; B60L 53/65; B60L 53/67; B60L 53/68; G06Q 10/0631

(57) ABSTRACT

An electric vehicle charging system organizes among a plurality of EV chargers in a location to coordinate access to the chargers. A scheduler, which can be a computer, communicates to the plurality of EV chargers in the location to determine a capacity of each of the plurality of chargers, and to determine information about EVs that are using the plurality of chargers and EVs that are waiting to use the plurality of chargers. The scheduler sends different vehicles to different chargers after determining a charger which is best matched to the maximum amount of charging that the first EV can accept.

### BACKGROUND

Electric vehicles (EVs) are becoming more popular around the world for many reasons. These include their zero emissions that help air quality, lower maintenance costs, increased performance-especially in urban environments, and social appeal.

The main concern among EV buyers and prospective buyers is range anxiety. EVs have a somewhat limited range—typically between 100 and 500 miles. The estimated range is displayed on the screen(s) in the vehicle like a traditional fuel gauge in an internal combustion vehicle. This estimated range is dynamic and depends on many factors including vehicle load, ambient temperature, wind speeds, topography, traffic and other factors or combinations thereof.

While EV users might prefer charging their vehicles at home or in their garage, often charging needs to occur while driving in public. This is especially true for longer trips such as going on vacation or visiting new places. While more and more EV charging stations are being constructed, there are approximately 67% fewer charging stations than gasoline stations in the United States as of the writing of this document. This fact gets worse though when considering the time to fill up a tank of gasoline (less than 5 minutes) to charging an empty EV battery to 100% (likely 20 minutes or more under ideal circumstances). This means that there is significantly less turnaround for EV chargers. Both of these facts mean potentially crowded EV charging stations and longer wait times for drivers needing a charge.

Another factor related to public charging is the type of EV and its technical specifications. There are two factors: One, manufacturers use different sized batteries. These batteries can range from as little as 10-kWh to as much as 150-kWh or higher. The battery size directly impacts range. For example, if a driver is averaging 3 miles per kWh, the driver could travel 300 miles with a 100-kWh battery. Two, manufacturers allow for varying charge rates or charge capacity. Some EVs can only charge at a maximum of 50-kWh while others can charge at 200-kWh or more.

Charging stations-especially the supercharging ones—have chargers that are rated at maximum energy delivery. This can range from less than 50-kWh to 350-kWh or more. So, using the example from before, a driver with a 100-kWh battery might need up to two hours to charge at the slowest station but less than 20 minutes at the 350-kWh station (provided that the driver's vehicle is capable of accepting this high charge rate).

Right now, as of the writing of this document, if you want to charge an electric vehicle, you just drive up to the charger, and plug-in. There may be many chargers, and they may be either in a bank, or in different locations, for example different spots within a parking garage. If there are many people wanting the charger, this may lead to a situation where you line up to wait for a charger.

### SUMMARY OF THE INVENTION

The inventors have recognized that the mismatch among EVs, EV batteries, battery charging capacities and EV charging stations is a problem. It creates a complicated matrix that is not understood by the public. EV users will attest that sometimes low charge capacity vehicles are using high output terminals at charging stations.

So, a Nissan Leaf (with a charge capacity of only 62.5-kWh) might be blocking a Porsche Taycan (with a charge capacity of 270-kWh) at a 350-kWh terminal. The Leaf driver might have arrived first, but the Leaf driver could have used a 100-kWh terminal with no adverse impact to charging time, whereas the Taycan driver is left waiting unnecessarily because that vehicle's charging is hindered by a slower terminal.

This mismatch leads to inefficiencies. These inefficiencies impact four constituencies.

First, it affects the EV driver or passenger. The driver or passenger needs to spend more time and effort looking for an optimal terminal at an EV charging station. They also waste time if they are charging at a lower rate than their battery can handle.

Second, it affects the EV manufacturers by way of demand. Many people have not purchased EVs due to range anxiety and the lack of EV infrastructure in the country. Furthermore, customers lose admiration for their EV if they are always stressed about charging.

Third, it affects EV stations. The chargers are less efficient and serve fewer customers each day due to improper allocation of their terminals.

Fourth, it affects the environment. Fewer EVs and less efficient charging means continued demand for gasoline and diesel-powered vehicles. It also requires more EV charging stations to be built-meaning less open space and more construction pollution and impact.

The present invention and its embodiments describe use of advanced software, computing power, and proprietary methods to increase the functionality and usability of electric vehicles and EV charging stations based on problems recognized by the inventors.

Embodiments describe situations and operations for addressing the difficult use cases of this type.

### BRIEF DESCRIPTION OF THE DRAWINGS

In the Drawings:

FIG. 1 shows a vehicle using the present system; and

FIG. 2 shows a flowchart of operation.

### DETAILED DESCRIPTION

In this application, EVs and vehicles may refer to automobiles, trucks, SUVs, vans, tractors, carts, ATVs, motorcycles, and all other powered machines that transport one or more people or items.

An embodiment uses a number of interconnected components to form a more advanced system or network of EVs and EV charging stations.

In an embodiment, the EV stations disclose and communicate their capacities to a program running on a computer. The computer can be a standalone or cloud computer, or can be the computer running in the EV, or the computer running in the EVs. The program that determines charging priority according to the techniques referred to herein is referred to herein as a scheduler. There can be one or many schedulers, communicating to determine optimum charging, all collectively referred to as a scheduler.

An embodiment describes a real-time system of communication between chargers and EVs and the user via the built in computer in the EV, and/or their smartphone or other computing device used by the user in the EV, using a scheduler.

The scheduler surveys the data from EV charging stations to determine the optimal choice for the driver/passenger and the vehicle. This can be done manually by the driver, or can be done automatically by the computer in the EV. Drivers can also provide certain kinds of input, for example saying “I don't like this one location”, or “I prefer charging stations that have at least 12 of the 300-kWh chargers”.

The scheduler can operate to consider other factors with artificial intelligence. These factors can include time of day, historical usage at the charging station, types of EVs frequenting the station, weather, special events and other issues in embodiments. These factors could be analyzed to help make better recommendations.

Once the determination of the proper charger is made, the EV provides detailed navigation to the driver or to its autonomous control system so that the EV would be driven to the right charging terminal. The driver would not need to look for terminal numbers or guess where to go.

The EV charging stations would have communication capabilities so that they could “talk” with incoming EVs-much like air traffic control at a busy airport. The charging station would then direct the vehicle and/or driver to the correct terminal. This could be accomplished with navigation instructions, lights, sounds or other signals.

The analogy of air traffic control for an EV charging station management system is helpful. Air traffic controllers know the pertinent information so that they can guide aircraft to the right spots at the right times. This would include aircraft type, fuel levels, airline, destination terminal and other factors. This proposed system creates a similar level of situational awareness.

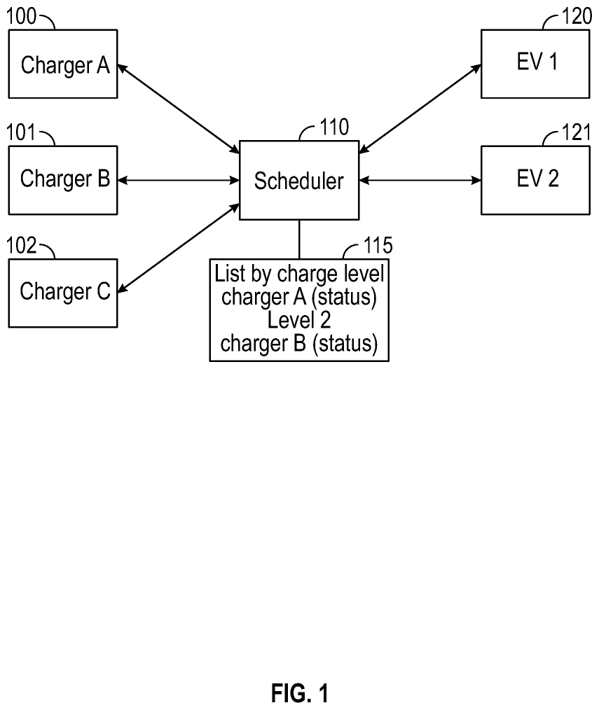

An embodiment is shown in FIG. 1. A number of vehicle chargers 100, 101, 102 are shown, although there will typically be many additional chargers. For example, it is not unusual for a charging station to have 10 to 50 chargers. In an embodiment, the chargers can be all from the same company, such as the way Tesla creates its own Tesla charger stations, or can be mixed chargers, created by different companies, auto companies, and aftermarket companies. In this way, a number of different companies can each put their chargers into a dedicated space or location, all of which are handled by, and assigned by, the scheduler.

Each of the chargers 100, 101 communicate with scheduler 110. The scheduler can be a program running in a standalone or cloud computer, or can be running in the computer running in the EV, or on a phone app.

The communication with the scheduler includes an initial set up step for any charger of providing the charger's actual capability, such as 100-kWh, 30-kWh, or whatever the charger's capability is. The communication also includes the charger indicating when it is available, when it is in use, and information obtained from the vehicle about how long the charging currently in use is likely to continue.

As described herein, the scheduler also sends information to the charger indicating which vehicle the scheduler has selected to charge on the charger next.

The scheduler also uses a database shown generically in 115. The database lists the different chargers by level. For example, a Level I charger may be one that can charge at up to 100 amps, and a Level II charger can charge up to 200 A. The database in 115 shows that charger A is a Level I charger, and also shows its status (for example busy, open, or out of order). The database also shows the group of Level II chargers, including charger B.

The scheduler 110 also communicates with a number of EV's, shown as 120, 121. There can again be any number of EV's. In one embodiment, the EV's communicates with the scheduler when the vehicles are within a certain range of the charger, for example when they are in a specified parking area around the charger. In another embodiment, the EV's can select a location where they are going to charge in the future, and communicate remotely with the scheduler, based on an ETA of when the vehicle will arrive at the charging location.

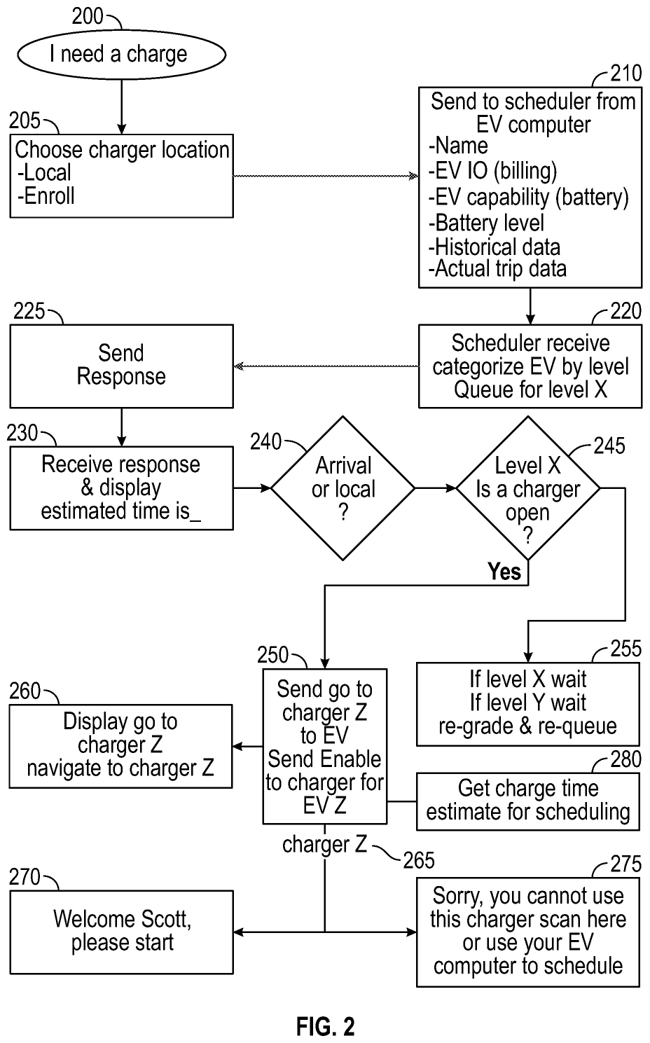

The schedule, vehicle, and chargers operate according to the flowchart of FIG. 2.

At 200, the vehicle creates an indication that it needs a charge. This can be the driver deciding this, or the vehicle deciding that it is at a point in its charge level, or a point in an ongoing trip, where it needs to find a charger.

At 205, the charger location can be selected as being local or enroute. If the user is already in a charging area, they can be set as local, which is the situation when a user pulls into a charging area and decides they want to charge. For this purpose, there can be informational signs or electronic messages being displayed in the area of the charger. The signs can say for example “use the EV scheduler app to schedule or to schedule a charger for your car”. There can also be QR codes or other similar ways to allow the user to use their phone, or other computer, to initiate the scheduler. Also, there can be an app or other computer operation that automatically begins to run in the vehicle upon reaching a location where EV charging is available, e.g., a pop up that automatically appears on the EV screen when the EV is in the vicinity of chargers saying “chargers are close by you want to schedule one?”.

However, if the vehicle is moving at the time the charger is selected, then the system is marked as enroute.

Once selecting this at 205, a number of detailed information is sent to the scheduler 115. This information is typically sent from the EV computer, which knows all of this information. The information is the user's name, the EV ID, which can be or include billing information or some other way of identifying the vehicle, the EV charging capacity, battery level, historical data, and actual trip data. The historical data can be an indication of the average or median information about previous charging station sessions. For example, some users may charge only to 70%, other users may charge to 100%. The scheduler can also infer the likelihood of the user charging to the different charge levels based on the historical information, for example by determining what charge level the EV user typically brings the vehicle to before leaving the charger. This can use a simple average of the charge level before the user typically leaves the charger, or can use a median, or a more complicated mathematical model, such as an average as a function of time of day. Based on any or all of this information, the scheduler estimates how long the vehicle will be at the charger, and provides a time estimate based on these calculations.

The scheduler receives all this information at 220, and characterizes the EV by level, indicating what charging level would be most appropriate for this specific EV at the specific level of charge. Both the capability of charging and also the charge level are taken into account for this characterization in one embodiment. This is because the level of charge in the battery sets the rate of charging that the battery will accept. As one example, even though a vehicle may be able to charge at 300-kWh, this 300-kWh may only be applicable when the battery is less than 20% charge. If the battery is over 50% charged, then even though the vehicle has a 300-kWh charging capability, it may still only be able to charge the 50% battery at 100-kWh. Consequently, both the charge level and the battery and the EV charge capability are taken into account when deciding what level charger is appropriate for the EV.

After categorizing what charging level is appropriate, the system automatically queues the EV for that level, referred to herein as level x. The scheduler sends a response at 225 to the EV, which is received by the EV at 230, and displayed. The message may be of the form “thanks Scott, we received your request to charge, and your estimated wait time for a charger is X minutes.”.

At 240 and based on the location of the vehicle as determined by the vehicles navigation system, it is determined that the vehicle has either arrived at the EV or is already local at the EV.

When the vehicle is at the location to be charged, a message is sent to the scheduler at 245, and the scheduler determines if a level X charger (appropriate for the vehicle's charging needs) is open or available. The user may have already been queued up by virtue of requesting charge at a previous time. If a level X charger is available, then at 250, the scheduler sends a message to both the charger and to the vehicle. The message to the vehicle indicates that the vehicle should go to charger C which has been assigned to the vehicle.

This is received by the vehicle at 260 and displayed on the display, which displays go to charger C, and also provides navigation instructions about how to get to charger C.

At 250, the scheduler also sends an enable to charger C for the specific EV. This is received by the charger at 265. Subsequently, the EV pulls up to the charger. If the correct EV has pulled up to the charger, and the charger recognizes the correct ID, the charger displays a message such as “welcome Scott please start”, at which time the charging begins.

However, if any other vehicle pulls up to the charger, the charger will not charge that other vehicle, and instead displays a message such as “sorry you cannot use this charger” and displays instructions for how to queue up for other chargers. For example, this may be a QR code which brings up the app or system that communicates to the scheduler or tells the user to use their EV computer to do the scheduling.

After the charging begins, at 280, information from the vehicle is used to estimate the charge time during which the vehicle will be at the charger. This can use both the charging and historical information to estimate an amount of time that the vehicle will be at the specific charger and to use that in future time estimates.

The queueing carried out at 245, queues a vehicle according to the appropriate charge level for the vehicle. However, a re-grading of queue level can be carried out at 285, if the wait time for level x is much greater than the wait time for level Y, which is a less ideal charger for the vehicle, then the car can be regraded and re-queued into the shorter line. While this is a less desirable outcome, it may be done in order to minimize the amount of time that a user has to wait.

This can be set by the system, but can for example automatically provide access to the vehicle if there is no line for an inappropriate charger or if the line for an appropriate charger is for example 10 minutes longer than the line for an inappropriate charger.

The invention allows for EVs and EV charging stations to communicate. This communication would occur through wireless transmissions utilizing cellular signals, GPS signals and NFC signals. The EV communicates its location, current battery level and draw rate, desired destination, and charge capacity. The charging station stacks or overlay this data against its current status. This status includes, in different embodiments, the number of terminals, occupancies, charge capacities and historical demand data.

In embodiments, once the EV, charger, and scheduler have communicated the relevant data, artificial intelligence would be utilized to maximize efficient outcomes. This would mean matching the right vehicle with the right charger at the right time. This allows for more throughput for the station, happier EV drivers/passengers, more revenue for stations and a cleaner environment.

The use of the described system has positive environmental impacts. Take a laundromat as an example. Most laundromats have many washers and dryers. Sometimes only one or two (out of perhaps 25) is being used. At this moment, the inefficiency is problematic. The reason for having 25 though is that at peak times, this is number that is needed. So, a laundromat owner builds in more capacity than is normally necessary to meet customer demands at any given point in time. This is problematic because unused or under-used resources like washing machines are a cost. Using the present system, EV charging stations are managed in a smart and dynamic way, leading to less need for more stations. This in turn means less infrastructure and more natural habitats versus concrete-paved charging station lots.

It also allows for many different vendors to cooperate in an EV charging environment in a more organized way. Many different vendors can put in charging systems, at different locations within a charging area (such as a parking lot or a parking garage) and the scheduler can automatically determine which user should go to which charger, and automatically direct them there. This also means, therefore, that the scheduler can help not only to make the load more efficient, but also to direct users to less used chargers, for example those which are in less prominent locations, thereby balancing the total amount of charging between the different chargers, and making it less likely that the chargers in prominent locations receive more business than the chargers and less prominent locations.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A method of selecting and using an EV charger in a location, comprising:
using a scheduling computer, communicating to a plurality of chargers in a location to determine a capacity of each of the plurality of chargers, and to determine information about EVs that are using the plurality of chargers and EVs that are waiting to use the plurality of chargers;
using the scheduling computer for receiving an indication from a first EV that the first EV requests to use charging in the location;
determining a maximum amount of charging that the first EV can accept;
using the scheduling computer for determining which of the plurality of chargers provides a charge capacity that is appropriate for the maximum amount of charging that the first EV can accept by selecting some of the plurality of chargers which have an appropriate charge capacity and excluding others of the plurality of chargers which do not have the appropriate charge capacity;
using the scheduling computer for assigning the first EV to a specific charger, based on the determining, where the assigning comprises providing a charger which is best matched to the maximum amount of charging that the first EV can accept;
the assigning including sending a message to the first EV including navigation instructions for the first EV to get to the specific charger, and
the first EV using the navigation instructions received in the message to navigate to the specific charger, and charging from the specific charger.

2. The method as in claim 1, further comprising maintaining a table of chargers including charge capacities of the plurality of chargers, in the scheduling computer,
dividing the chargers into groups according to their charge capacity,
the groups defining a minimum level of charge and a maximum level of charge that each charger in the group can provide,
and assigning an EV to a specific charger when the EV is capable of accepting charge at least at the minimum level.

3. The method as in claim 2, further comprising using the scheduling computer for analyzing a current level of charge in the first EV to determine the maximum amount of charging that the first EV can accept using both a charging capability of the first EV and the current level of charge of the first EV.

4. The method as in claim 1, further comprising using the scheduling computer to use information about a maximum amount of charging that the first EV can accept and amount of charge on the first EV currently using the charger to determine an estimated time that the first EV will be at the charger, and providing an estimate of how long until another EV can use the charger, and sending a message to the another EV based on the estimate.

5. The method as in claim 1, further comprising using the scheduling computer to assign the first EV to a specific charger by sending a message to the specific charger with information about the first EV and enables the specific charger to charge the first EV, and sending a message to be displayed on the first EV with information about the specific charger.

6. (canceled)

7. The method as in claim 5, wherein the specific charger prevents EVs other than the first EV from charging at the specific charger.

8. The method as in claim 1, further comprising using the scheduling computer to communicate with a number of different chargers having different owners in the location and selecting a most appropriate charger for the first EV among the different chargers having the different owners.

9. The method as in claim 1, further comprising using the scheduling computer to create a queue of vehicles for each of the groups of chargers.

10. An electric vehicle charging system, comprising:
a plurality of EV chargers in a location;
a scheduling computer, communicating to the plurality of EV chargers in the location to determine a capacity of each of the plurality of chargers, and to determine information about EVs that are using the plurality of chargers and EVs that are waiting to use the plurality of chargers;
the scheduling computer receiving an indication from a first EV that the first EV requests to use charging in the location, and determining a maximum amount of charging that the first EV can accept; and
the scheduling computer determining which of the plurality of chargers provides a charge capacity that is appropriate for the maximum amount of charging that the first EV can accept, and assigns the first EV to a specific charger, based on the determining, where the scheduling computer analyzes the charge capacity of the plurality of chargers, and the maximum amount of charging that the first EV can accept to determine a charger which is best matched to the maximum amount of charging that the first EV can accept;
wherein the assigning the first EV to a specific charger comprises sending a message to the first EV including navigation instructions for the first EV to navigate to the specific charger,
and where the first EV use the navigation instructions received in the message to navigate to navigate to the specific charger, and to charge from the specific charger.

11. The system as in claim 10, wherein the scheduling computer maintains a table of chargers including charge capacity of the chargers in the scheduling computer,
the scheduling computer dividing the chargers into groups according to their charge capacity,
where the groups defining a minimum level of charge and a maximum level of charge that each charger in the group can provide,
and the scheduling computer assigning an EV to a specific charger when the EV is capable of accepting charge at least at the minimum level of charge.

12. The system as in claim 10, wherein the scheduling computer analyzes a current level of charge in the first EV to determine the maximum amount of charging that the first EV can accept using both a charging capability of the first EV and the current level of charge of the first EV.

13. The system as in claim 10, wherein the scheduling computer uses information about a maximum amount of charging that the first EV can accept and an amount of charge on the first EV currently using the charger to determine an estimated time that the first EV will be at the charger, and provides an estimate of how long until another EV can use the charger, and sends a message to the another EV based on the estimate.

14. The system as in claim 10, wherein the assigning the first EV to a specific charger comprises sending a message to the specific charger with information about the first EV and where the message enables the specific charger to charge the first EV, and sending a message to be displayed on the first EV with information about the specific charger.

15. (canceled)

16. The system as in claim 10, wherein the specific charger prevents EVs other than the first EV from charging at the specific charger.

17. The system as in claim 10, wherein the scheduling computer communicates with a number of different chargers having different owners in the location and selects the most appropriate charger for the first EV among the different chargers having different owners.

18. The system as in claim 10, wherein the scheduling computer creates a queue of vehicles for each of the groups of chargers.
